(19) United States
(12) Patent Application Publication
(10) Pub. No.: US 2015/0094082 A1
(43) Pub. Date: Apr. 2, 2015

(54) CHANNEL ESTIMATION USING CYCLIC CORRELATION

(71) Applicant: QUALCOMM INCORPORATED, San Diego, CA (US)

(72) Inventors: Alok Kumar Gupta, Encinitas, CA (US); Siavash Ekbatani, San Diego, CA (US)

(73) Assignee: QUALCOMM INCORPORATED, San Diego, CA (US)

(21) Appl. No.: 14/042,634

(22) Filed: Sep. 30, 2013

(51) Int. Cl. H04W 64/00; H04L 25/03; H04L 25/02

(52) U.S. Cl. CPC H04W 64/00; H04L 25/0204; H04L 25/03; H04L 25/0216
USPC 455/456.1; 375/349

(57) ABSTRACT

Methods, systems, and devices for channel estimation and/or earliest path detection in a location tracking system are described. The described tools and techniques may involve accumulation of energy of multiple copies of a periodic sequence, which may be contained and/or associated with a signal transmitted from a location tracking tag. One or more access points within the location tracking system may receive and process multiple copies of the sequence, employing period-wise coherent accumulation, and estimate an earliest path, or a corresponding delay associated with an earliest path, of the sequence. The access point(s) may transmit information related to the earliest path, including the corresponding delay, to a tracking management server, which may use the information to estimate and/or determine a location of a tag.

### BACKGROUND

In some settings, such as in indoor and enterprise environments, it may be important to easily locate various types of assets or people, or both. Examples of such settings include hospitals, retail stores, warehouses, etc. The accuracy and speed with which the location of assets or people is monitored in an indoor setting may be an important factor in determining the usefulness of the tracking system. In addition, having a tracking system that is cost effective, scalable, and that can provide continuous, accurate, and precise location monitoring is also desirable.

Different systems and devices may be used to locate assets and/or people in a particular indoor environment. An ultra-wideband (UWB) network, or some other radio frequency network deployed throughout at least a portion of the indoor environment, may be configured to perform indoor tracking. Systems may employ multiple access points (APs) placed at specific locations in the indoor environment. A location tracking tag also may be attached to each mobile asset and/or to each person to be tracked. The tag may send waveforms (e.g., beacon signals) that are received by the APs for ranging measurements to determine the distance between the tag and the APs that receive the waveforms. Once the distances between the tag and at least three different APs are obtained, triangulation or trilateration may be used to estimate the location of the asset or person to which the tag is attached.

Estimating a tag location may involve determining a time of arrival of a signal from a tag. A signal may be transmitted from a tag at a known time, but in order to accurately determine time of arrival, it may be desirable to determine a direct path of a signal and/or estimate a delay of the direct path. It may also be desirable to implement earliest path detection schemes that minimize mathematical complexity.

### SUMMARY

Described below are methods, systems, and devices that provide for receiving and processing a signal from a tag in order to estimate a direct path and/or a delay of a direct path. These methods, systems, and devices may be implemented in a manner that limits mathematical complexity and thus reduces implementation hardware complexity. A receive device, such as an AP, may receive and process a periodic sequence transmitted from a tag at a known start time (e.g., at an expected sequence receive time). Estimating a direct path and/or direct path delay may include coherent accumulation of each of several periods of a sequence. The estimating may include receive filtering, time and frequency correction, and channel impulse response computation. The described tools and techniques may be utilized to select and design hardware for a receiver with minimal jitter.

In some embodiments, a method to perform channel estimation is provided. The method may include identifying a period of each of multiple copies of a sequence. The method may further include identifying a period of each of multiple channel estimation windows, where the period of each of the channel estimation windows may be based on the period of each of the multiple copies of the sequence. And the method may involve accumulating energy of each of the multiple copies of the sequence during each of the multiple channel estimation windows, where a first channel estimation window may be initiated before an expected sequence receive time.

In some cases, the method also includes estimating a carrier frequency offset and estimating an expected range of residual frequency error of the sequence.

The method may also include estimating a chip rate of the sequence.

According to some embodiments of the method, accumulating energy of each of the multiple copies of the sequence includes receiving samples at an estimated chip rate of the sequence and correcting the received samples for an estimated carrier frequency offset.

In some embodiments, the method includes selecting one of the corrected sample buffers for further processing.

Additionally or alternatively, the method may involve correcting the selected sample based on an expected range of residual frequency error of the sequence.

In some embodiments, the method includes filtering the selected sample for pulse shaping.

In some cases, the method involves computing, utilizing correlation, a channel impulse response.

The method may also include determining an earliest path of the sequence; and/or it may include transmitting the determined earliest path to a tracking management server.

In some embodiments, the method includes updating the expected sequence receive time.

According to some embodiments of the method, the expected sequence receive time includes a scheduled time mapped to a local timer at one or more access points.

In some embodiments of the method, accumulating energy of each of the multiple copies of the sequence includes coherently accumulating energy of each of the multiple copies of the sequence.

In some cases, the sequence of the method has a perfect autocorrelation property. In some embodiments, the sequence is a ternary sequence.

In other embodiments, a system for channel estimation is provided. The system may include means for identifying a period of each of multiple copies of a sequence. The system may also include means for identifying a period of each of multiple channel estimation windows, where the period of each of the channel estimation windows is based on the period of each of the multiple copies of the sequence. In some case, the system includes means for accumulating energy of each of the multiple copies of the sequence during each of the multiple channel estimation windows, where a first channel estimation window may be initiated before an expected sequence receive time.

Additionally or alternatively, the system may include means for estimating a carrier frequency offset and means for estimating an expected range of residual frequency error of the sequence.

In some cases, the system has means for estimating a chip rate of the sequence.

In some embodiments of the system, the means for accumulating energy of each of the multiple copies of the sequence includes means for receiving samples at an estimated chip rate of the sequence and means for correcting the received samples for an estimated carrier frequency offset.

The system may also include means for selecting a corrected sample buffer for further processing and/or means for correcting the selected sample based at least in part on an expected range of residual frequency error of the sequence.

In some embodiments, the system includes means for filtering the selected sample for pulse shaping and/or means for computing, utilizing correlation, a channel impulse response.

In some cases, the system includes means for determining an earliest path of the sequence and/or means for transmitting the determined earliest path to a tracking management server.

Additionally or alternatively, the system may include means for updating the expected sequence receive time.

According to some embodiments of the system, the expected sequence receive time includes a scheduled time mapped to a local timer at one or more access points.

In further embodiments of the system, the means for accumulating energy of each of the multiple copies of the sequence involves means for coherently accumulating energy of each of the multiple copies of the sequence.

In some cases, the sequence of the system has a perfect autocorrelation property. For example, the sequence may be a ternary sequence.

In other embodiments an apparatus for channel estimation includes: a processor; memory in electronic communication with the processor; and instructions stored in the memory. The instructions may be executable by the processor to cause the apparatus to: identify a period of each of multiple copies of a sequence; identify a period of each of multiple channel estimation windows, where the period of each of the channel estimation windows may be based on the period of each of the multiple copies of the sequence; and accumulate energy of each of the multiple copies of the sequence during each of the multiple channel estimation windows, where a first channel estimation window may be initiated before an expected sequence receive time.

In some embodiments, the apparatus also includes instructions executable to estimate a carrier frequency offset and estimate an expected range of residual frequency error of the sequence.

The apparatus may also include instructions executable to cause the apparatus to estimate a chip rate of the sequence.

In some embodiments of the apparatus, the instructions executable by the processor to accumulate energy of each of the multiple copies of the sequence during each of the multiple channel estimation windows are executable to cause the apparatus to receive samples at an estimated chip rate of the sequence and correct the received samples for an estimated carrier frequency offset.

In some cases, the instructions are executable to cause the apparatus to select the corrected sample buffer for further processing.

In some embodiments the instructions are executable to cause the apparatus to correct the selected sample based at least in part on an expected range of residual frequency error of the sequence.

The instructions also may be executable to cause the apparatus to filter the selected sample for pulse shaping.

In some embodiments, the instructions are executable to cause the apparatus to compute, utilizing correlation, a channel impulse response.

In some cases, the instructions are further executable to cause the apparatus to determine an earliest path of the sequence.

Additionally or alternatively, the instruction may be executable to cause the apparatus to transmit the determined earliest path to a tracking management server.

In some embodiments, the instructions are executable to cause the apparatus to update the expected sequence receive time.

In still further embodiments, a computer program product for channel estimation is provided. The computer program product may include a non-transitory computer-readable medium storing instructions executable by a processor to cause an apparatus to: identify a period of each of multiple copies of a sequence; identify a period of each of multiple channel estimation windows, where the period of each of the channel estimation windows may be based on the period of each of the multiple copies of the sequence; and accumulate energy of each of the multiple copies of the sequence during each of the multiple channel estimation windows, a first channel estimation window may be initiated before an expected sequence receive time.

In some embodiments, the computer program product includes instructions executable to cause a processor to estimate a carrier frequency offset and estimate an expected range of residual frequency error of the sequence.

The computer program product may also include instructions executable to cause a processor to estimate a chip rate of the sequence.

Additionally or alternatively, the instructions may be executable cause the apparatus to receive samples at an estimated chip rate of the sequence and/or correct the received samples for an estimated carrier frequency offset.

In some embodiments, the computer program product includes instructions executable by the apparatus to select the corrected sample buffer for further processing.

In some cases, the instructions of the computer program product are further executable to cause the apparatus to correct the selected sample based at least in part on an expected range of residual frequency error of the sequence.

In some embodiments of the computer program product, the instructions are executable to cause the apparatus to filter the selected sample for pulse shaping.

The computer program product may also include executable to cause the apparatus to: compute, utilizing correlation, a channel impulse response; determine an earliest path of the sequence; and transmit the determined earliest path of the sequence to a tracking management server.

Additionally or alternatively, the computer program product may include instructions executable to cause the apparatus to update the expected sequence receive time.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B show an example(s) of a location tracking system in accordance with various embodiments;

FIG. 2 shows a block diagram of an example device that may be employed in location tracking systems in accordance with various embodiments;

FIG. 3A shows a block diagram of an example device that may be employed in location tracking systems in accordance with various embodiments;

FIG. 3B shows a flow diagram of example operations that may be employed in location tracking systems in accordance with various embodiments;

FIG. 3C shows a flow diagram of example operations that may be employed in location tracking systems in accordance with various embodiments;

FIG. 3D shows a flow diagram of example operations that may be employed in location tracking systems in accordance with various embodiments;

FIG. 3E shows a flow diagram of example operations that may be employed in location tracking systems in accordance with various embodiments;

FIG. 3F shows a flow diagram of example operations that may be employed in location tracking systems in accordance with various embodiments;

FIG. 4 shows a block diagram of an example of a location tracking system in accordance with various embodiments;

FIG. 5 shows a block diagram of an example of a location tracking system in accordance with various embodiments;

FIG. 6 shows a block diagram of an example of a location tracking system in accordance with various embodiments;

FIG. 7 is a flow diagram of a method of channel estimation in a location tracking system in accordance with various embodiments;

FIG. 8 is a flow diagram of a method of channel estimation in a location tracking system in accordance with various embodiments; and

FIG. 9 is a flow diagram of a method of channel estimation in a location tracking system in accordance with various embodiments.

### DETAILED DESCRIPTION

Methods, systems, and devices are described that address issues pertaining to estimating a channel, in general, and an earliest path of a signal, in particular. Earliest path detection, which may also be referred to as direct path detection, may involve coherent accumulation of multiple copies of a periodic sequence. In a location tracking system, for example, a tag unit may transmit M copies of a periodic sequence of length N, starting at a time known a priori by a set of access points (APs). The APs may receive and process multiple copies of the sequence, employing period-wise coherent accumulation, and estimate an earliest path, or a corresponding delay associated with an earliest path, of the sequence (e.g., an UWB signal). The APs may transmit information related to the earliest path, including the corresponding delay, to a tracking management server.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

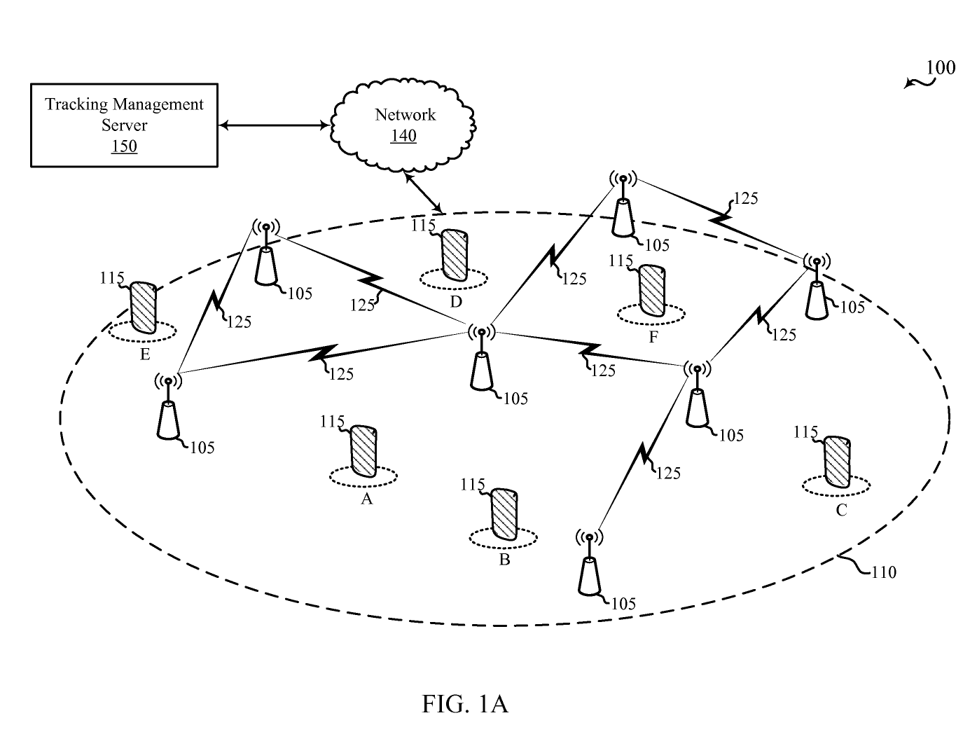

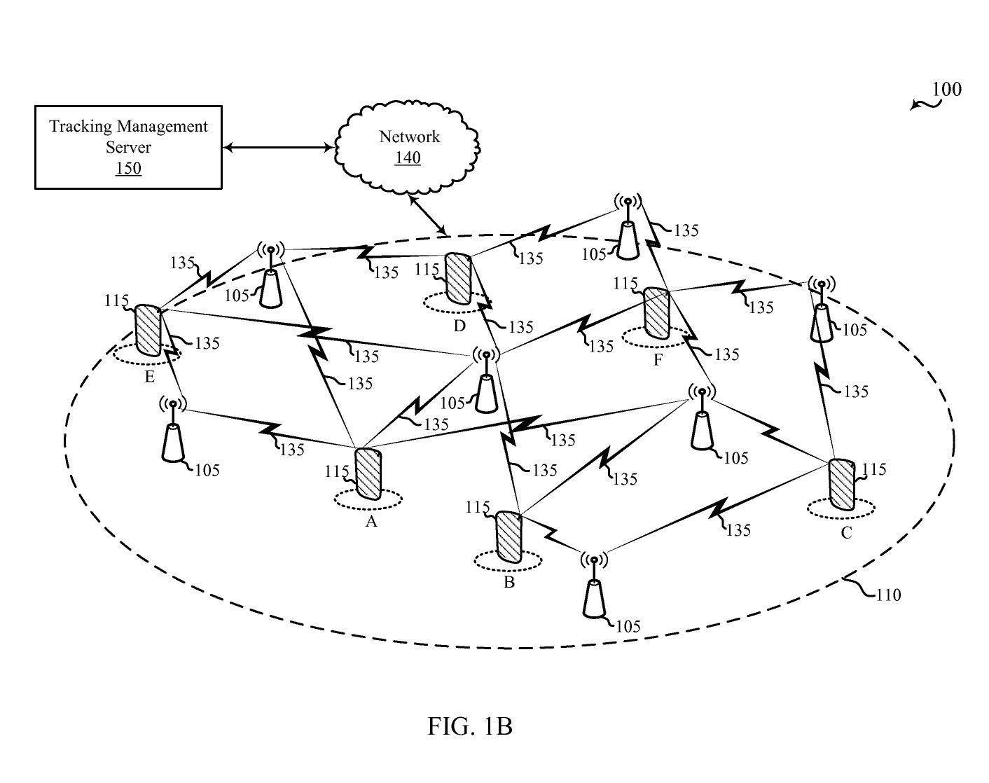

First, FIG. 1A depicts an example of a location tracking 100 in accordance with various embodiments. The system 100 provides location tracking of assets (e.g., objects) or people, or both, throughout the coverage area 110 associated with an indoor and/or enterprise environment. In some embodiments, the coverage area 110 represents an area of coverage inside a building, such as a hospital, a retail store, or a warehouse. Within the coverage area 110, multiple APs 105 may be deployed at specific locations, as may multiple tag units 115 (also referred to as location tracking tags or tags), which may be tracked within the coverage area 110. Because of their stationary nature, the exact distance between any two APs 105 is typically known, or may be determined, throughout the operation of the system 100. Any two APs 105 may ascertain the distance between themselves through a ranging operation, which may be a two-way ranging operation. The ranging operation may be performed via communication links 125.

The arrangement of APs 105 shown in FIG. 1A is intended as a non-limiting example. The APs 105 may be deployed or distributed within the coverage area 110 in a manner or pattern different from that depicted in FIG. 1A. For example, the APs 105 may be arranged at different distances form one another. In some cases, the coverage area 110 may represent a two-dimensional deployment, such as a single floor within a building. But in some embodiments, the APs 105 are deployed in a three-dimensional manner by placing some of the APs 105 on different floors or levels of a building within the coverage area 110.

Each of the APs 105 may be equipped with a narrowband transceiver or a UWB transceiver, or both. Additionally or alternatively, the APs 105 may include one or more oscillators or timers, or both. The oscillators may each produce a repetitive, oscillating electronic signal, which may be adjustable and/or variable. The oscillators may be RF oscillators. The oscillators may be linear- or relaxation-type. In some embodiments, the oscillators are voltage controlled, temperature compensated crystal oscillators (VCTCXO). The timers may include quartz clock(s), they may be digital, and/or they may be implemented in software or as a counter in hardware.

The APs 105 may need to undergo a calibration procedure in order to increase the precision and/or accuracy of the tracking system 100. Calibration may include synchronizing the APs 105 to one another, to a network 140, and/or to a tracking management server 150. Additionally or alternatively, calibration may include determining coordinates of each AP 105.

In some cases, one or more APs 105 are designated or selected as master APs or acting master APs that facilitate synchronization. Network-wide synchronization of APs 105 may involve designating or selecting a master AP 105 with a stable oscillator and stable timer. Each of the other APs 105 may synchronize their respective oscillators and timers to the master AP or to an acting master AP. This synchronization may include coarse and fine synchronization steps, which, in some embodiments, involves receiving and transmitting both narrowband and UWB signals.

Calibration may also include determining the coordinates of each of the APs 105 within the coverage area 110. Coordinates of each of the APs 105 may be determined incrementally, based on known coordinates of one of the APs 105 and known or determined distances between APs 105.

Each of the tag units 115 may be attached to an asset or person being tracked within the coverage area 110. The tag units 115 may be equipped with a narrowband transceiver or a UWB transceiver, or both. The tag units 115 may also have one or more oscillators or timers, or both. The oscillators may each produce a repetitive, oscillating electronic signal, which may be adjustable and/or variable. The oscillators may be RF oscillators. The oscillators may be linear- or relaxation-type. By way of example, the oscillators are VCTCXO. The timers may include quartz clock(s), they may be digital, and/or they may be implemented in software or as a counter in hardware.

FIG. 1A depicts an example location tracking system 100 with six tag units at locations A, B, C, D, E, and F. Over time, these locations may change as the assets or people to which the tags 115 are attached move or are moved within the coverage area 110. The system 100, shown with six tags 115, is intended as a non-limiting example of a location tracking system. Those skilled in the art will recognize that the system 100 is scalable, and it may be capable of tracking more or few assets or people.

The system 100 includes a tracking management server 150, which also may be referred to as a locating tracking server and a tag tracking management server. In some embodiments, the tracking management server 150 is connected to the APs 105 through a network 140. The connection may be by way of a radio network associated with the APs 105. The tracking management server 150 may receive information from the APs 105 to perform various types of calculations, including: determining one or more sets of receive filters for the APs 105; detecting whether a tag 115 is mobile or stationary and adjusting update rates accordingly; estimating characteristics of communication channels; and/or estimating a location of an asset or person being tracked within the coverage area 110. The tracking management server 150 may also schedule or coordinate various operations associated with the APs 105, including when to have an AP 105 wirelessly communicate (e.g., when to transmit UWB and/or narrowband signals) with other APs 105 or with tags 115. In some embodiments, the tracking management server 150 stores information about different APs 105 and subsets of APs 105; and it may use stored information to schedule or coordinate various operations between individual APs 105 and/or subsets of APs 105.

Next, FIG. 1B illustrates transmissions or broadcasts between APs 105 and tags 115 via communication links 135. In some embodiments, the tags 115 communicate with APs 105 via the communication links 135 using either or both UWB and narrowband signals. Whether a tag 115 communicates primarily with narrowband or UWB may be a function of whether the tag 115 is mobile or stationary.

A tag 115 may transmit a UWB signal that includes M copies of a periodic sequence of length N. The tag 115 may transmit the UWB signal at a time known to the APs 105. In some cases, the APs 105 are informed of this transmit time and/or an expected receive time via a narrowband broadcast sent from another AP 105, such as a master or acting master AP 105. One or more APs 105 may identify a period of each of multiple copies of the sequence. In some embodiments, the tag 115 transmits a sequence with perfect autocorrelation property. For example, a transmitted sequence may be constructed from a ternary sequence.

The APs 105 may also identify a period of each of multiple channel estimation windows. These channel estimation windows may be a defined period during which the APs 105 “look” for an earliest path of a transmitted signal. The period of each channel estimation window may be based, for example, on the period of the transmitted sequence. In some embodiments, the APs 105 accumulate energy (e.g., using coherent accumulation) of each received copy of the sequence during each channel estimation window. The APs 105 may initiate a first channel estimation window before the expected arrival time of the tag's 115 UWB signal.

According to some embodiments, the APs 105 utilize several inputs (e.g., to a UWB transceiver or processor) before receiving and processing a UWB signal from a tag 115. For example, the APs 105 may estimate a carrier frequency offset or an expected range of a residual frequency error of a signal, or both. An AP 105 may also estimate, or receive an estimated, chip rate of a transmitted UWB signal. In some cases, the carrier frequency offset and the transmitted chip rate are estimated based on a preamble of a packet transmitted from a tag 115 to the APs 105 via a narrowband link. Additionally or alternatively, the tracking management server 150 may convey to each AP 105 information related to transmit time and/or an expected receive time, carrier frequency offset, transmitted chip rate, and/or residual frequency error. For example, a transmit time and/or an expected receive time may correspond to a scheduled time for channel estimation, which scheduled time may be mapped to the APs 105.

In some embodiments, an AP 105 receives samples (e.g., copies of a transmitted sequence) at an estimated chip rate, and the AP 105 corrects the samples for an estimated carrier frequency offset. Then, the AP 105 may select one of the corrected sample buffers for further processing. The selected sample may be corrected based on an expected range of residual frequency error, and then it may be filtered for pulse shaping. In some cases, an AP 105 utilizes the filtered sample to compute, by correlation, a channel impulse response. The AP 105 may then correct the sample time (e.g., the transmit time or an expected receive time) based on the channel impulse response. Sampling time correction may be employed to provide chip rate sampling at an optimum time—e.g., at a peak of a combined transmitted and received pulse. In some embodiments the channel impulse response is processed and an earliest path, and corresponding delay, of a signal are determined. The earliest path delay may be communicated from an AP 105 to the tracking management server 150.

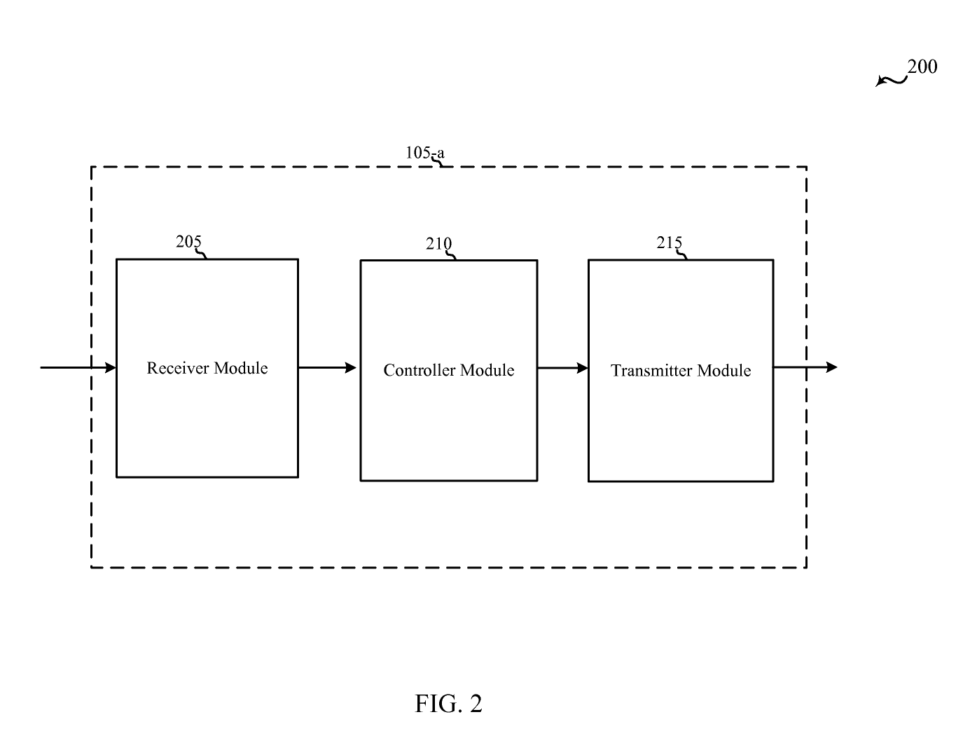

Turning to FIG. 2, a block diagram 200 illustrates a device 105-a configured for channel estimation in accordance with various embodiments. The device 105-a may be an AP, which may be an example of an AP 105 of FIG. 1A or FIG. 1B, or both. The device 105-a may also be a processor. The device 105-a may include a receiver module 205, a controller module 210, and/or a transmitter module 215. Each of the modules of the device 105-a may be in communication with each other.

In some embodiments, the components of the device 105-a are, individually or collectively, implemented with one or more application-specific integrated circuits (ASICs) adapted to perform some or all of the applicable functions in hardware. Alternatively, the functions may be performed by one or more processing units (or cores), on one or more integrated circuits. In other embodiments, other types of integrated circuits are used (e.g., Structured/Platform ASICs, field-programmable gate arrays (FPGAs), and other Semi-Custom integrated circuits (ICs)), which may be programmed in any manner known in the art. The functions of each unit also may be wholly or partially implemented with instructions embodied in a memory, formatted to be executed by one or more general or application-specific processors.

By way of illustration, the device 105-a, through the receiver module 205, may receive an UWB signal, e.g., from a tag 115. The receiver module 205 may receive copies of a sequence, which may be transmitted in the UWB signal. These copies may be referred to as samples. The sequence may be received at an estimated chip rate. The controller module 210 may identify a period of each received copy of the sequence. The controller module 210 may also identify a period of several channel estimation windows. In some embodiments, the period of the channel estimation windows are based on the period of the received sequence. The controller module 210 may accumulate energy of each copy of the sequence (e.g., each sample) during each of the channel estimation windows. In some cases, the controller module 210 initiates a first channel estimation window before a known sequence transmit time—e.g., a known time when a tag 115 is schedule to transmit a UWB signal. In other cases, the controller module 210 initiates a first channel estimation window before an expected receive time—e.g., before a known time when a sequence transmitted from a tag 115 is expected to arrive. The controller module 210 may correct the received samples for estimated carrier frequency offset, which, in some cases, is conveyed to the controller module 210 from a tracking management server.

The controller module 210 may select a corrected sample for further processing. In some embodiments, further processing occurs within the controller module 210, and includes: correcting the selected sample based on an expected residual frequency error; filtering the selected sample for pulse shaping; computing, using correlation, a channel impulse response; and determining and earliest path of the sequence. The controller module 210 may also determine a delay associated with the earliest path.

In some embodiments, the transmitter module 215 transmits a determined earliest path, or an earliest path delay, or both to a tracking management server. For example, the device 105-a, which may be an AP, may transmit, via the transmitter module 215, an earliest path delay to the tracking management server 150.

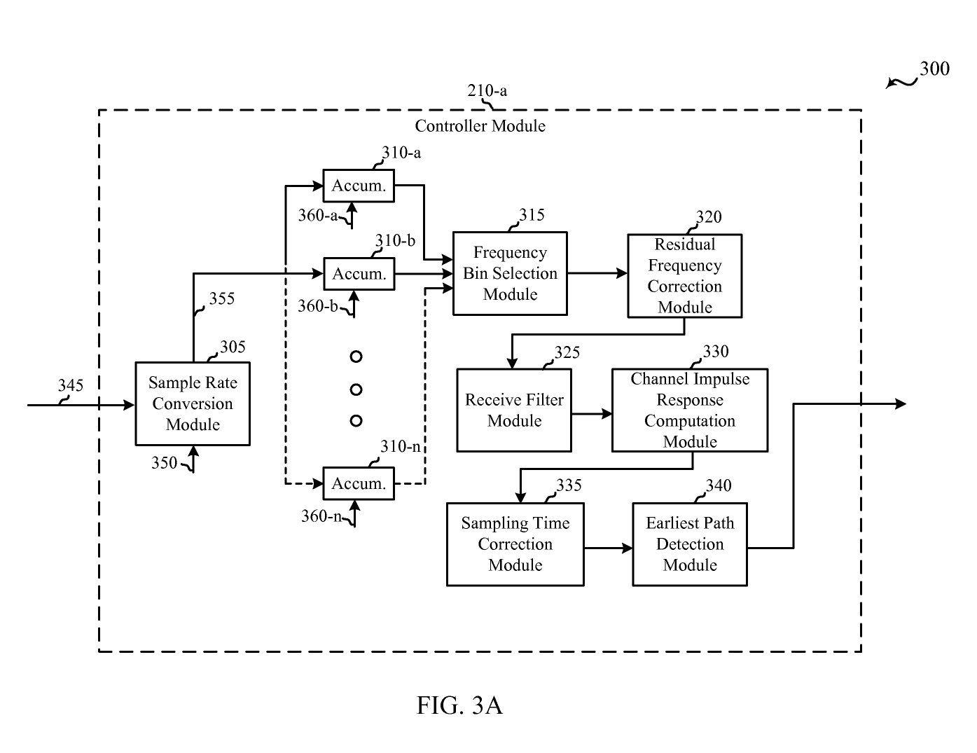

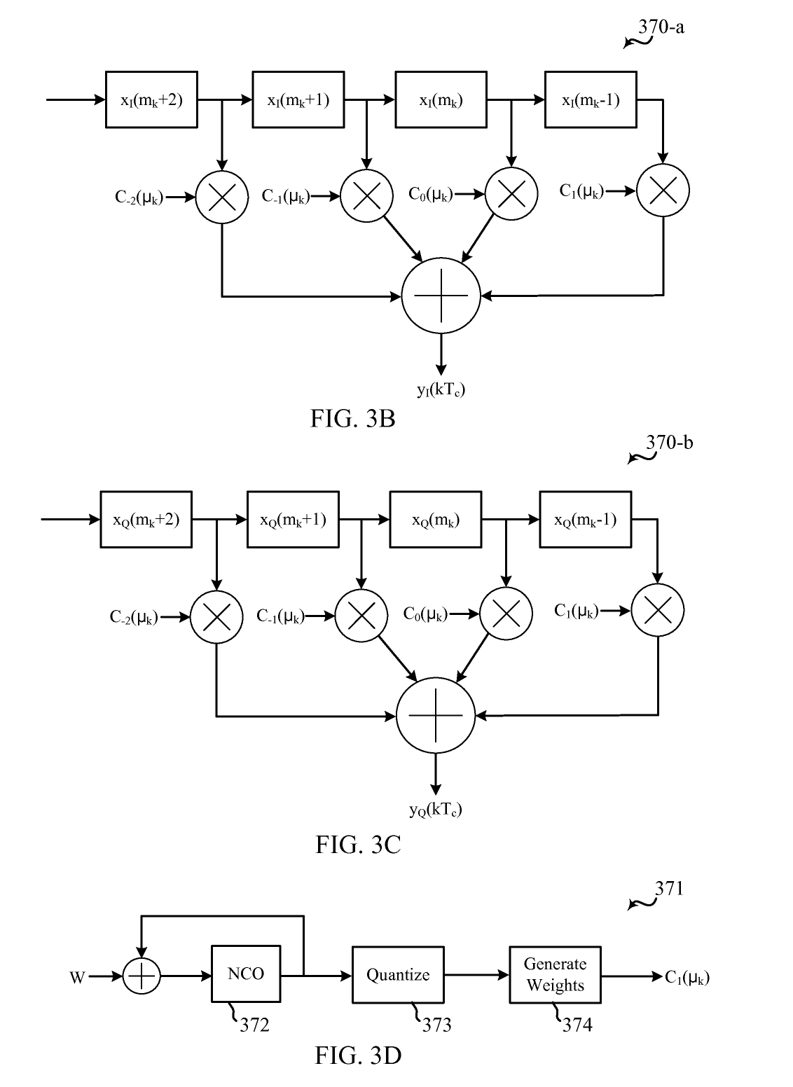

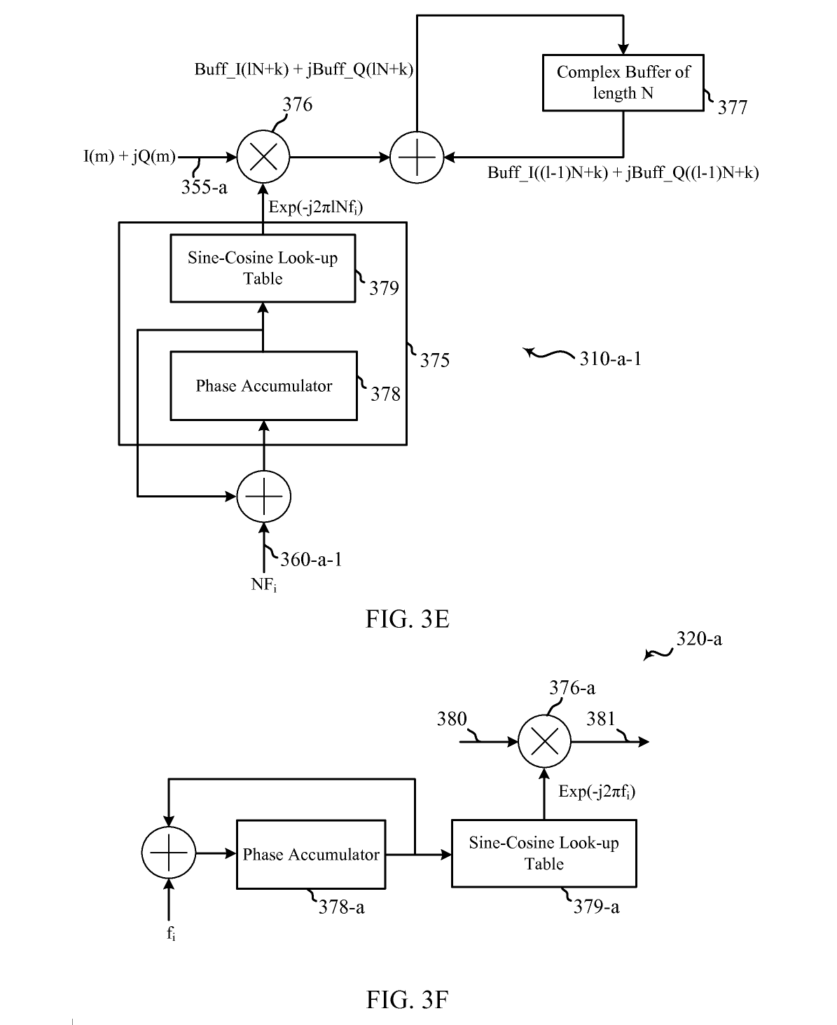

Next, FIG. 3A shows a block diagram 300 of a device 210-a configured for channel estimation in accordance with various embodiments. The device 210-a may be a controller module, which may be an example of the controller module 210 of FIG. 2; and the device 210-a may perform the same or similar functions as described above for the controller module 210. In some embodiments, the device 210-a is an example of various aspects of AP 105, described above with reference to any or all of FIGS. 1A, 1B, and 2. The device 210-a may also be a processor. In some cases, the device 210-a includes, a sample rate conversion module 305, an accumulation modules 310, a frequency bin selection module 315, a residual frequency correction module 320, a receive filter module 325, a channel impulse response computation module 330, a sampling time correction module 335, and/or an earliest path detection module 340. Each of the modules may be in communication with each other.

According to some embodiments, the components of the device 210-a are, individually or collectively, implemented with one or more ASICs adapted to perform some or all of the applicable functions in hardware. In other embodiments, the functions of device 210-a are performed by one or more processing units (or cores), on one or more integrated circuits. In other embodiments, other types of integrated circuits are used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

The sample rate conversion module 305 may identify a period of each of multiple copies of the sequence. In some cases, the identified copies of the sequence include complex samples. The sample rate conversion module 305 may also identify a period of each of multiple channel estimation windows. The sample rate conversion module 305 may accept as an input samples 345, which may be multiple copies of the sequence, during each of the channel estimation windows. In some embodiments, the samples 345 are output from the receiver module 205 described with reference to FIG. 2. The sample rate conversion module 305 may also accept as an input an estimated chip rate 350. The estimated chip rate may be conveyed to the controller module 210-a from a tracking management server 150. So, in some cases, the sample rate conversion module 305 receives samples at some sampling rate outputs samples 355 of the received sequence (e.g., copies of the received sequence) at the estimated chip rate 350. For example, the sample rate conversion module 305 receive samples at a 1.248 GHz sampling rate, which may be the rate and it may output samples at a nominal value chip rate (e.g., 1.125 GHz) as transmitted from a tag 115.

By way of example, the sample rate conversion module is configured to receive (e.g., accept) and convert I and Q samples to a chip rate sample. The sample rate conversion module 305 may include an FIR filter with time-varying filter coefficients. A numerically controlled oscillator (NCO) configured to run at an input sample rate may provide a rate control (e.g., a time to generate a new chip rate sample at an output) and control selection of an appropriate sets of filter coefficients for computing a chip rate output sample. A rate conversion operation may be defined as follows:

$$y ( {kT}_{c} ) = {\sum }_{i = {I}_{1}}^{{I}_{2}} x [ ( {m}_{k} - i ) {T}_{s} ] h [ ( i + {μ}_{k} ) ] , \qquad ( 1 )$$

where x(m) is a sequence of input samples taken at a sampling period T_{S} and h(t) is an impulse response of an interpolating filter. The above operations may deliver a chip rate sample y(k) at a chip period T_{C}, where T_{C} is generally incommensurate with T_{S}. Parameters for generating a chip rate sample may include a filter index i=I₁ to I₂; a basepoint index mₖ, which may identify the I=I₂−I₁+1 input samples to be used for a kth interpolant; and a fractional interval μₖ, which may identify the I filter coefficients to be employed for the kth interpolant.

FIGS. 3B, 3C, and 3D are flow diagrams 370-a, 370-b, and 371 that illustrate operations of the sample rate conversion module 305, according to various embodiments. Diagrams 370-a and 370-b depict operations of Equations 1 and resulting values y(k) for an input sample composed of I and Q. FIG. 3D shows an NCO 372, which may operate at a sampling rate F_{S}, which may be associated with the sampling period T_{S}. In some cases, the NCO 372 operates according to the following:

$$ω ( m ) = [ ω ( m - 1 ) + W ] mod 1 , \\ where = \frac{{F}_{c}}{{F}_{s}} , \qquad ( 2 )$$

such that F_{S} denotes an input sampling clock frequency and F_{C} denotes a desired output chip rate. When a new input sample is shifted in, the NCO 372 may be updated. In some embodiments, the chip rate output sample is computed only when NCO 372 overflows.

The value μ may be obtained from quantizing ω(m) at block 373 into some small number of bits (e.g., five (5) bits). The filter coefficients h[(i+μ)T_{S}]=Cᵢ(μ) may be generated at block 374 and may be defined as follows:

C₋₂(μ)=αμ²−αμ, (3)

C₋₁(μ)=−αμ²+(α+1)μ, (4)

C₀(μ)=αμ²+(α−1)μ+1, (5)

C₁(μ)=αμ²−αμ, (6)

where α is a design parameter. For example, for four-point interpolation using piecewise-parabolic interpolating filters, α=0.5 may be used. As those skilled in the art will note, for α=0, Equations 3-6 reduce to a linear interpolation such that C₋₁(μ)=μ, C₀(μ)=1−μ, C₁(μ)=0 and C₂(μ)=0. In some embodiments, a set of receive filter coefficients for different values of μ are stored in memory (e.g., read only memory), in a look-up table.

In one example, a 32-bit NCO provides 0.29 Hz chip-rate resolution, which may provide sufficient results for implementation of the present disclosure.

The accumulator modules 310 (FIG. 3A) may accumulate energy of each sample 355—e.g., each of the multiple copies of the sequence—during each of the multiple channel estimation windows. The first channel estimation window may be initiated before a sequence transmit time, which may be communicated to the controller module 210-a by the tracking management server 150. In some embodiments, the accumulation modules 310 each accumulate energy for a sample 355 according to a specified frequency range, which may be indicated by frequency bins 360 (e.g., Doppler bins). In some cases, estimates of a carrier frequency offset and/or an expected range of residual error of the sequence are obtained from a special preamble transmitted over the narrowband link from an AP 105. But in some embodiments, the tracking management server 150 conveys an estimated carrier frequency offset and/or an expected range of residual frequency error of the sequence to the controller module 210-a. The accumulator modules 310 may thus receive samples 355 at an estimated chip rate 350; and the accumulator modules 310 may correct the received samples for an estimated frequency offset. For example, accumulator module 310-a may receive a sample 355 at an estimated chip rate 350, and it may correct the received sample 355 for an estimated carrier frequency offset according to a frequency bin 360-a. In some embodiments, the individual samples 355 of the received periodic sequence are corrected for specified frequency offset (e.g., frequency error) before being accumulated into a buffer of length N.

By way of illustration, the accumulation modules 310 may be configured for period-wise coherent accumulation, which may involve the following. Common symbols from different periods of a transmitted sequence first may be corrected for estimated frequency error before accumulating them into a buffer of length N chips. For example, the accumulator modules 310, during an lth period of a received sequence, where l=0, 1, 2, . . . M−1, may be summarized as follows:

$$Buff\_I ( lN + k ) + j Buff\_Q ( lN + k ) = Buff\_I ( ( l - 1 ) N + k ) + j Buff\_Q ( ( l - 1 ) N + k ) + Exp ( - j 2 π {lNf}_{i} ) * [ I ( m ) + j Q ( m ) ] , \qquad ( 7 )$$

where: k=0, 1, 2, . . . , N−1; Buff_I and Buff_Q represent buffers of length N; fᵢ is a normalized frequency offset of an ith Doppler bin; and l(m)+jQ (m) represents a current input sample.

FIG. 3E shows a flow diagram 310-a-l, which may represent operations of an accumulator module 310 according to various embodiments. The accumulator modules 310 may be coherent accumulators, and they may each include a digital oscillator module 375, a phase rotator 376, and a buffer 377 of length N samples 355-a. In some embodiments, the digital oscillator consists of a phase accumulator 378 and a sine-cosine generator 379 (e.g., a sine-cosine look-up table), and it runs at 1/N of the chip rate. The phase rotator 376 and the phase accumulator 378 may run at the chip rate.

In some cases, coherent loss due to residual frequency error may be given by 20 log 10(sin(πTΔf), where T is a total integration period and Δf is a residual frequency offset. For example, for T=20 ms and Δf=20 Hz, the coherent loss is 2.42 dB. Therefore, in order to maintain the coherent loss around 0.5 dB, residual frequency error may be 10 Hz or less. Because of residual frequency error from frequency estimation and from frequency offset associated with Doppler shift, multiple accumulator modules 310 may be employed, each performing frequency correction by a different Doppler bin 360 (e.g., the Doppler bin 360-a-l).

The number of accumulator modules 310 may vary depending on integration period and/or residual frequency error after frequency estimation, and in view of the Doppler shift resulting from a tag's 115 motion. In some embodiments, at least eight (8) accumulator modules 310 (e.g., coherent accumulators) may be used.

By way of example, if N=1143, a 21-bit phase accumulator 378 may provide 0.46 Hz frequency resolution, which may provide sufficient results for implementation of the present disclosure. Additionally or alternatively, a sine-cosine generator 379 may generate outputs of varying sizes. In some embodiments, outputs of five (5) or six (6) bits are sufficient.

Referring again to FIG. 3A, the frequency bin selection module 315 may select one or more corrected sample buffers for further processing—e.g., the frequency bin selection module 315 may select one buffer with maximum accumulated energy for further processing as the corresponding frequency bin represents the frequency closest to the actual frequency offset of the received signal. In some embodiments, p Doppler bins 360 and accumulator modules 310 are employed, and the frequency bin selection module 315 may select a corrected sample with a frequency correction closest to that of a received signal frequency offset. The frequency bin selection module 315 may, for example, compute energy of each chip in a received buffer and accumulate energy if it is greater than some threshold. The contents of the selected buffer(s), along with the estimated frequency error, may then be passed to the residual frequency correction module 320, where each sample may be rotated to correct for residual frequency error.

In some embodiments, the residual frequency correction module 320 is configured to correct residual frequency error for each selected buffer (e.g., the buffer 377 of FIG. 3E). For example, the residual frequency correction module 320 may employ the following:

Buff_{—}I(k)+jBuff_{—}Q(k)=Exp(−j27πfᵢ)*[Buff_{—}I(k)+jBuff_{—}Q(k)], (8)

where k=0, 1, 2, . . . , N−1, Buff_I and Buff_Q represent the selected buffer of length N; and fᵢ is a normalized frequency offset of the selected Doppler bin.

FIG. 3F shows a flow diagram 320-a, which may represent operations of the residual frequency correction module 320, according to various embodiments. The residual frequency correction module may include a phase rotator 376-a, a phase accumulator 378-a, and/or a sine-cosine generator 379-a (e.g., a sine-cosine look-up table), which may perform similar functions to the corresponding components of an accumulator module 310, described with reference to FIG. 3E.

In some cases, after the selected buffer content 380 are corrected for residual frequency error, the frequency-corrected samples 381 are passed through the receive filter module 325 (FIG. 3A) for further pulse shaping. Receive filtering may include up-sampling by two (2) for time correction. In such cases, the receive filter module 325 includes a pair of filters.

Referring back to FIG. 3A, a number of samples of a channel impulse response may be computed with the channel impulse response computation module 330. By way of example, the channel impulse response computation module 330 includes a buffer which accepts and contains a number N of the coherently accumulated, frequency-corrected, and receive-filtered samples, at the estimated chip rate, of a sequence Sₖ. For example, these samples may be represented by Zₖ, where k=0, 1, 2, . . . , N−1. The sequence Sₖ may be a ternary sequence of length N, where each element of Sₖ E {+1, −1, 0}, and Sₖ is obtained by inserting eight (8) zeros after each element of the ternary sequence. The N samples, at the estimated chip rate, of the channel impulse response, hⱼ, where j=0, 1, 2, . . . , N−1, may be obtained by

$${h}_{j} = {\sum }_{k = 0}^{N - 1} {Z}_{k} {S}_{k - j}^{′} , \qquad ( 9 )$$

where S′ₖ₋ⱼ is the sequence obtained from circularly shifting the sequence Sₖ to the right by j positions.

Those skilled in the art will note that a computation of each may require sixty-four (64) complex additions or subtractions. For example, where N=1143, the complexity of channel impulse response estimation may thus involve 1143×64 operations, where each operation is complex addition or subtraction. The skilled artisan will also recognize that in may be unnecessary to compute all N elements of the impulse response, thereby reducing computational complexity and thus the complexity of implementation hardware.

After a channel impulse response is computed, the sampling time correction module 335 may determine whether chip rate sampling is occurring at an optimum time. For example, the sampling time correction module 335 may determine whether the sample consists of the peak of a combined transmitted and received pulse. The sampling time correction module 335 may, as necessary, update the expected sequence receive time at the sample rate conversion module 305.

According to some embodiments, the chip rate channel impulse response is obtained by sampling a received pulse at a peak. Thus, the sampling time correction module 335 may employ two steps: (1) estimating a timing error τ, where

$$- \frac{{T}_{c}}{2} \leq τ \leq \frac{{T}_{c}}{2} ;$$

and (2) generating a timing corrected channel impulse response by interpolating the impulse response in the buffer having the appropriate phase.

For example, the timing error may be estimated as follows. A channel impulse response for maximum magnitude is designated hₘ, and

hₘ=hᵢ, where |hᵢ|²≦|hₖ|² for ∀k≠i. (10)

Using a polyphase filter, L interpolated sample hᵢₙₜₚ (k) around hₘ may be generated by

$${h}_{intp} ( k ) = h ( m + k \frac{{T}_{c}}{L} ) , - \frac{L}{2} \leq k \leq \frac{L}{2} , \qquad ( 11 )$$

where the parameter L determines a sample time correction resolution. The sampling timing error τ is thus given by

$$τ = Arg \{ \begin{matrix}max \\ k\end{matrix} {\vert {h}_{intp} ( m + k \frac{{T}_{c}}{L} ) \vert}^{2} \} , \qquad ( 12 )$$

and τ may be computed for a set of local peaks defined as

p={hᵢ, where |hᵢ|²>T, and hᵢ is a local maximum}. (13)

T may denote some programmable threshold. The final error τ may be based on a majority decision or a weighted average.

Once a timing error is estimated, the impulse response samples in the buffer may be interpolated with the correct phase to generate a sampling-time corrected channel impulse response. In some embodiments, the polyphase filter utilized for computing sampling timing error may be used for impulse response interpolation.

By way of example, sampling time correction includes the following. First, selecting current peaks of the channel impulse response (e.g., a peak may be defined where the magnitude is greater than some threshold and it is a local maximum). Second, generating interpolated samples around an individual peak (e.g.,

$$a peak \pm \frac{{T}_{c}}{2} ) .$$

For a resolution of

$$\frac{{T}_{c}}{16} ,$$

sixteen (16) interpolated samples may need to be generated around the peak: eight (8) before and 8 after. Third, timing phase error may include interpolating phase with respect to the peak where the magnitude of the interpolated sample is a maximum among the existing peak and L new samples around it.

Then, according to some embodiments, the earliest path detection module 340 may process a computed channel impulse response and determine an earliest path of the sequence, which may represent a first arriving (e.g. a direct path) of a UWB signal. The earliest path detection module 340 may, additionally or alternatively, determine a delay corresponding to the earliest path. In some cases, the earliest path detection module 340 sends information about the earliest path or the corresponding delay, or both, to the tracking management server 150. For example, the controller module 210-a may send information about the earliest path and/or the corresponding delay, to the tracking management server 150 via the transmitter module 215.

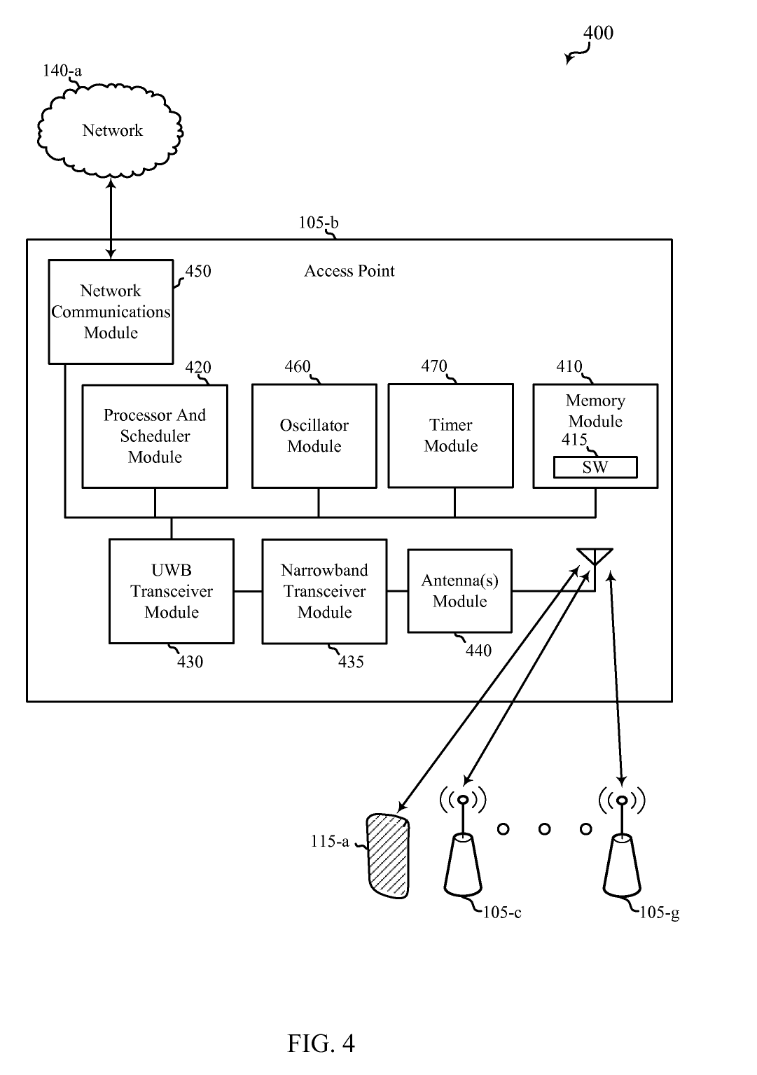

Turning now to FIG. 4, which depicts a block diagram of a system 300 configured for channel estimation in accordance with various embodiments. The system 300 may include APs 105-b and 105-c through 105-g, which may be examples of the APs 105 described with reference to one or more of FIGS. 1A, 1B, 2, and 3. The AP 105-b may include a memory module 410, which, in some embodiments, includes a software module 415. The AP 105-b may include a processor and scheduler module 420, a UWB transceiver module 430, a narrowband transceiver module 435, antenna(s) module 440, a network communications module 450, an oscillator module 460, and/or a timer module 470. Each of the components of the AP 105-b may be in communication with each other. The network communications module 450 may be in communication with the network 140-a, which may be an example of the network 140 of FIGS. 1A and 1B. The network communications module 450 may facilitate communication with a tracking management server (e.g., the tracking management server 150) via the network 140-a.

The memory module 410 may include random access memory (RAM) and read-only memory (ROM). In some embodiments, the memory module 410 also stores computer-readable, computer executable software (SW) code 415 containing instructions configured to, when executed, cause the processor and scheduler module 420 to perform various functions described herein related to channel estimation. For example, the SW code 415 may contain instructions configured to, when executed, cause the processor and scheduler module 420 to perform substantially the same functions described with reference to the controller module 210 and 210-a of FIGS. 2 and 3. In other embodiments, the software (SW) code 315 may not be directly executable by the processor and scheduler module 320; but it may be configured to cause a computer, e.g., when compiled and executed, to perform the functions described herein related to channel estimation.

The processor and scheduler module 420 may include an intelligent hardware device, such as a central processing unit (CPU). The processor and scheduler module 420 may perform various operations associated with channel estimation. The processor and scheduler module 420 may use scheduling information received from, for example, the tracking management server 150, by way of the network 140-a, to perform channel estimation and earliest path detection functions. For example, the processor and scheduler module 420 may receive a sequence time before which it should initiate a channel estimation window. Additionally or alternatively, the processor and scheduler module may receive information from the tracking management server 150 such that the processor and schedule module may estimate a carrier frequency offset, estimate an expected range of residual frequency error of a sequence, and/or estimate a chip rate of a sequence. In some embodiments, however, estimates of carrier frequency offset, an expected range of residual frequency error of a sequence, and/or a chip rate of a sequence are made at the tracking management server 150, and those estimates are transmitted to the processor and scheduler module 420 via the network 140-a and the network communications module 450.

The processor and scheduler module 320 may be configured to perform various operations including identifying a period of multiple copies of a sequence. It may also be configured to identify a period of multiple channel estimation windows, which have a period based on the period of the multiple copies of the sequence. And in some embodiments, the processor and scheduler module 420 is configured to accumulate energy of multiple copies of the sequence during each of the multiple channel estimation windows. In some cases, the processor and scheduler module 420 may be further configured to, before accumulating energy of copies of the sequence, receive samples at an estimated chip rate of the sequence and/or correct the received samples for an estimated carrier frequency offset.

By way of example, the processor and scheduler module 420 is also configurable to perform other channel estimation operations, including: selecting a corrected sample for further processing; correct the selected sample based on an expected range of residual frequency error of the sequence; filter the selected sample for pulse shaping; and/or compute channel impulse response. In some embodiments, the processor and scheduler module 420 employs Equation 1, discussed above, to compute the channel impulse response. The processor and scheduler module 420 may also be configured to determine an earliest path of the sequence, which may be sent (e.g., transmitted wirelessly or with a wired connection) to the tracking management server 150 via the network communications module 450 and the network 140-a. In still further embodiments, the processor and scheduler module 420 is configured to determine an optimum sample time and to update the sequence time.

Either or both of the UWB transceiver module 430 and narrowband transceiver 435 may include a modem configured to modulate data (e.g., packets) and provide the modulated data to the antenna(s) module 440 for transmission, and to demodulate data received from the antenna(s) module 440. Some embodiments of the AP 105-b include a single antenna; other embodiments include multiple antennas. As shown in FIG. 4, signals transmitted from a tag 115-a may be transmitted or received, or both, by the AP 105-b via the antenna(s) in the antenna(s) module 440. For example, a UWB signal from the tag 115-a may be received via the antenna(s) module 440, demodulated with the UWB transceiver module 430 and communicated to the processor and scheduler module 420. The received signal may consist of multiple copies of a sequence (e.g., a ternary sequence), which the processor and scheduler module 420 may receive at a sampling rate, and which, before processing, it may convert to samples at a chip rate.

The AP 105-b may also wireless communicate with other APs, such as APs 105-c through 105-g. In some embodiments, the AP 105-b may receive signals, including UWB, narrowband, and reference signals from other APs 105; and the AP 105-b may use the received signals for calibrating, synchronizing, and/or determining a location of a tag unit 115. In some cases, the AP 105-b may transmit received signals to the tracking management server 150 via the network communications module 450 and the network 140-a.

The timer module 470 may keep time from the processor and scheduler module 420, as well as for other components of the AP 105-b. In some case, the tracking management server 150 transmits a schedules time, via the network 140-a and the network communications module 450, to the timer module 470. The processor and scheduler module 420 may map the scheduled time to the timer module 470, which, in some cases, maintains a local timer based on the scheduled time. This scheduled time mapped to the timer module 470 may be the sequence time utilized by the processor to initiate a first channel estimation window. For example, the scheduled time may be mapped to a local timer at the timer module 470.

In some cases, a local timer at each AP 105 is runner at 32 MHz, and the schedule time is transmitted (or otherwise conveyed) to each AP 105 from the tracking management server 150 or from one AP 105 to every other AP 105. Each AP 105 may have a processing delay associated with its receiver. For example, the AP 105-b may have a processing delay of tₚᵣₓ that corresponds to an antenna and RF processing delay associated with either or both of the UWB transceiver Module 430 and the narrowband transceiver module 435—e.g., tₚᵣₓ may be the delay between the arrival of a signal at the antenna(s) module 440 and a time when sample accumulation in the processor and scheduler module 420 begins. In some embodiments, tₚᵣₓ is fixed and common for each AP 105. Those skilled in the art will therefore appreciate that the UWB transceiver module 430 may be implemented with a hardware design to limit jitter of tₚᵣₓ on the order of a few hundreds of pico seconds.

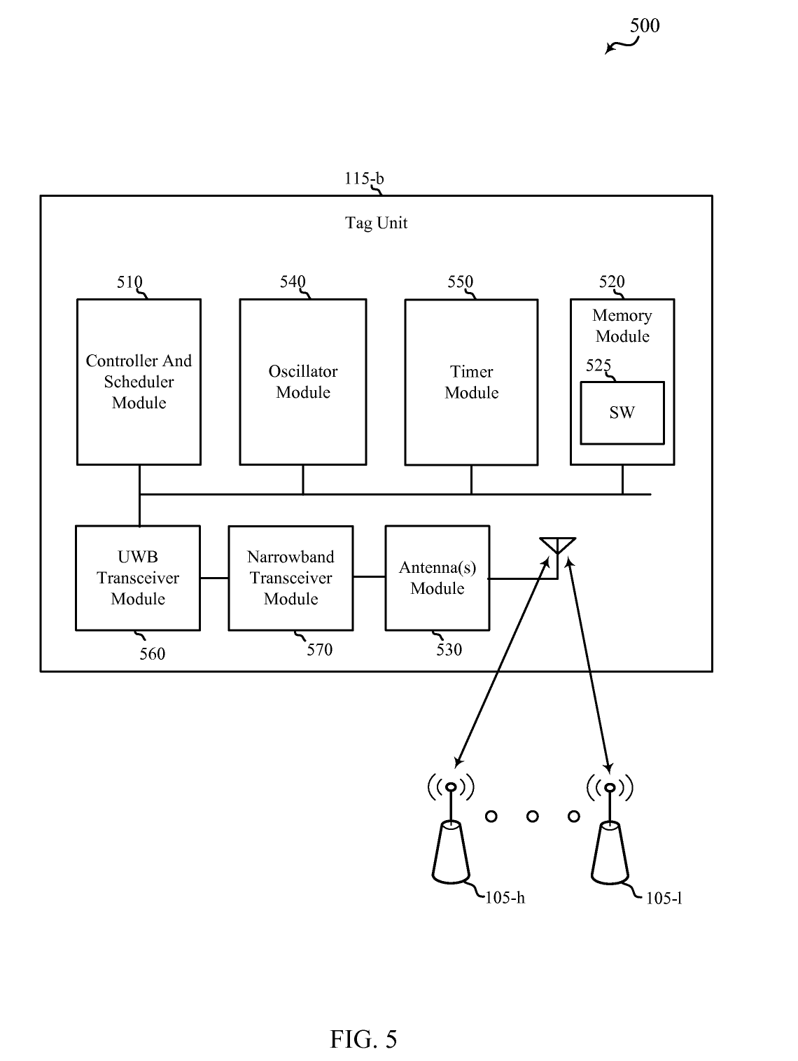

Next, FIG. 5 shows a block diagram illustrating a system 500 configured for channel estimation, which may include a tag unit 115-b. In some embodiments, the tag unit 115-b includes one or more aspects of the tag units 115 of any or all of FIGS. 1A, 1B, and 4. The tag unit 115-b may include a controller and scheduler module 510, a memory module 520, a UWB transceiver module 560, a narrowband transceiver module 570, and antenna(s) module 530. In some embodiments, the tag unit 115-b includes an oscillator module 540 or a timer module 550, or both. The oscillator module 540 and the timer module 550 may each include several oscillators and timers, respectively.

By way of illustration, the controller and scheduler module 510 includes logic or code, or both, that enables it to control the operations of the tag unit 115-b. In some cases, the controller and scheduler module 510 includes a microcontroller or a state machine to control the UWB transceiver module 560 and the narrowband transceiver module 570.

The memory module 520 may include random access memory (RAM) or read-only memory (ROM), or both. In some embodiments, the memory module 520 stores computer-readable, computer-executable software (SW) code 525 containing instructions that are configurable to, when executed, cause the controller and scheduler module 510 to perform various functions described herein related to channel estimation. In other embodiments, the software code 525 is not directly executable by the controller and scheduler module 410, but it may be configured to cause a computer, for example, when compiled and executed, to perform functions described herein.

The UWB transceiver module 560 may support radio frequency (RF) communication technology to broadcast UWB signals through the antenna(s) module 530. Likewise, the narrowband transceiver module 570 may support RF communication technology to broadcast narrowband signals through the antenna(s) module 530. In some embodiments, the UWB transceiver module 560 or the narrowband transceiver module 570, or both, include a modulator (not shown) to modulate location tracking information and provide the modulated information to the antenna(s) module 530 for transmission of signals. For example, the UWB transceiver module 560 may broadcast an UWB signal via the antenna(s) module 530. By way of example, the broadcast signal consists of M copies of a periodic sequence N, transmitted at a transmit time known by APs 105-h through 105-l. In some cases, N=1143, which is a sequence constructed from a ternary sequence of length 127 by inserting eight (8) zeros after each element. The quantity M may be a programmable number, and it may be the function of a total desired integration length. For example, M may have maximum value of 20,000, which corresponds to a maximum preamble duration of 20.32 msecs.

FIG. 5 shows broadcast and reception of signals between the tag unit 115-b and several APs 105. In the system 500, at least two APs 105-h and 105-l are shown communicating with the tag unit 115-b; but the tag unit 115-b may communicate with more or fewer APs 105.

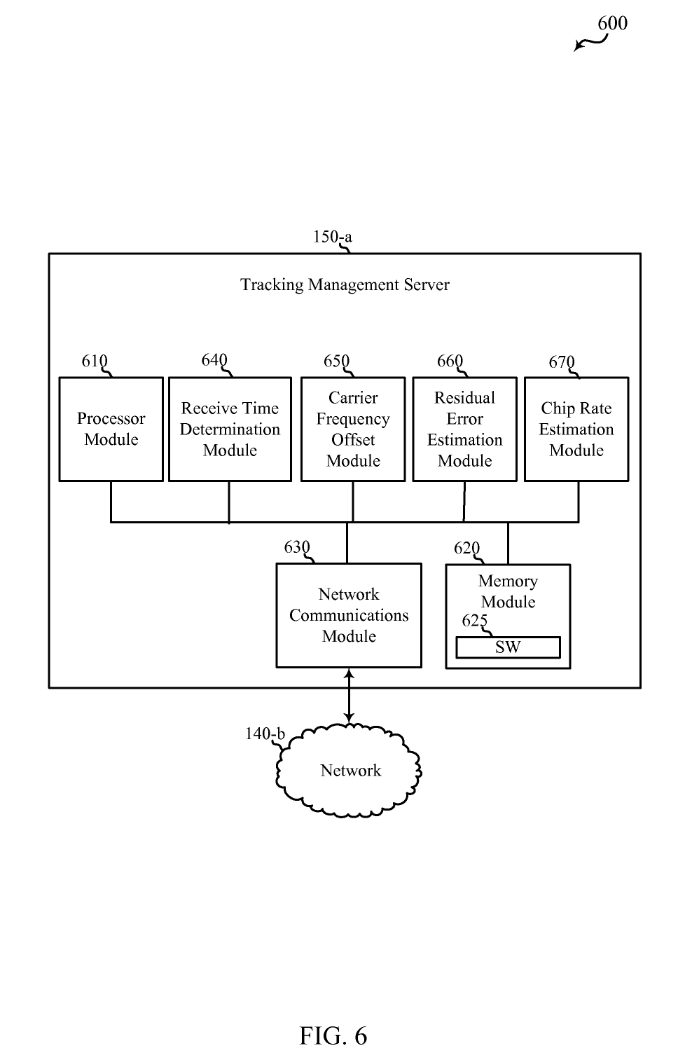

Referring now to FIG. 6, a system 600 is illustrated with a block diagram. The system 600 is configured for channel estimation in accordance with various embodiments. In some embodiments, the system 600 includes a tracking management server 150-a, which may be the tracking management server 150 of FIGS. 1A and/or 1B. The tacking management server 150-a may include a processor module 610, a memory module 620 (which may include a software (SW) module 625), a network communications module 630, a receive time determination module 640, a carrier frequency offset module 650, a residual frequency error estimation module 660, and/or a chip rate estimation module 670. Each of the modules may be in communication with one another.

The processor module 610 may perform various operations and may include an intelligent hardware device, e.g., a CPU. In some embodiments, the processor module 610 performs various operations associated with channel estimation. The tracking management server 150-a also may communicate with a network 140-b through the network communications module 530 to receive information from the APs 105 and/or to send information to the APs 105. The network 140-b may be an example of the networks 140 of any or all of FIGS. 1A, 1B, and 4.

The memory module 620 may include RAM and/or ROM. In some embodiments, the memory module 620 stores computer-readable, computer-executable software (SW) code 625 containing instructions that are configured to, when executed, cause the processor module 610 to perform various functions described herein. In other embodiments, the software code 625 may not be directly executable by the processor module 610; but the software code module may be configured to cause a computer, e.g., when compiled and executed, to perform functions described herein.

The receive time determination module 640 may determine and/or estimate a scheduled time that may correspond to the expected time when a transmitted sequence will arrive an the APs 105 and before which the APs 105 are to initiate channel estimation windows. The carrier frequency offset module 650 may estimate a carrier frequency offset, which may be used by the APs 105 in processing samples. The residual frequency error estimation module 660 may estimate an expected range of residual frequency error associated with channel estimation, which may be used by the APs 105 in correcting accumulated samples. The chip rate estimation module 670 may estimate a chip rate for UWB signals broadcast from tags 115, and the chip rate estimate may be used by the APs 105 in processing samples of a sequence. Each of the estimates of the various modules may be based on and/or provided by a user input.

By way of example, the estimates of each module are transmitted to the APs 105, e.g., via the network communications module 630 and the network 140-b. In some cases, the estimated chip rate and the estimated carrier frequency offset are transmitted from the tracking management server 150-a to each AP 105—e.g., to the sample rate conversion module 305 of the controller module 210-a, which may be an aspect of each AP 105. Likewise, the estimated expected range of residual frequency error may be transmitted to each AP 105—e.g., to the residual frequency correction module 320 of the controller module 210-a. In some cases, the tracking management server 150-a receives, via the network 140-b and the network communications module 630, a determined earliest path (and/or corresponding delay) form each of the APs 105.

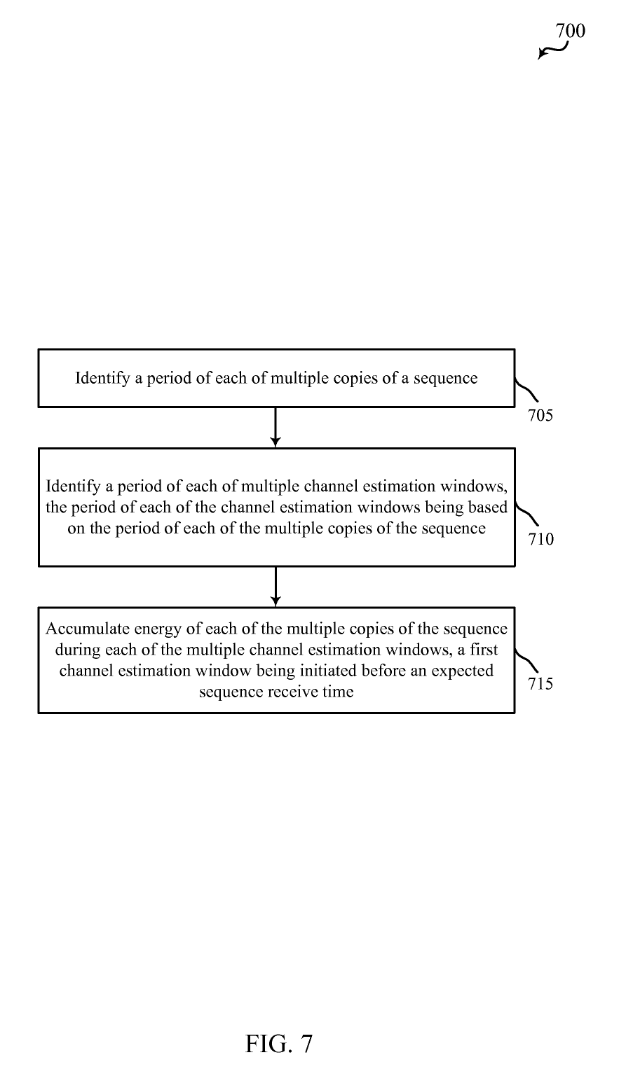

Next, FIG. 7 shows a flow diagram, which illustrates a method 700 of channel estimation in a location tracking system, according to some embodiments. By way of illustration, the method 700 is implemented using the one or more of the devices and systems 100, 200, 300, 400, and 600 of FIGS. 1A, 1B, 2, 3, 4, and 6.

At block 705, the method may include identifying a period of each of multiple copies of a sequence. The operations at block 705 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 710, the method may involve identifying a period of each of multiple channel estimation windows, the period of each of the channel estimation windows being based on the period of each of the multiple copies of the sequence. The operations at block 710 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 715, the method may further include accumulating energy of each of the multiple copies of the sequence during each of the multiple channel estimation windows, a first channel estimation window being initiated before an expected sequence receive time. In some embodiments, accumulating energy of each of the multiple copies of the sequence includes receiving samples at an estimated chip rate of the sequence and/or correcting the received samples for an estimated carrier frequency offset. In still further embodiments, accumulating energy of each of the multiple copies of the sequence involves coherently accumulating energy of each of the multiple copies of the sequence. Additionally or alternatively, the expected sequence receive time may include a scheduled time mapped to a local timer at one or more APs 105. In some cases, the sequence has a perfect autocorrelation property. For example, the may include (e.g., be constructed of) a ternary sequence. The operations at block 715 may in some cases be performed by the controller module 210 of FIG. 2; the controller module 210-a and/or the accumulator modules 310 of FIG. 3A; the processor and scheduler module 420 and/or the timer module 470 of FIG. 4, and/or the processor module 610 of FIG. 6.

Those skilled in the art will recognize that the method 700 is but one implementation of the tools and techniques discussed herein. The operations of the method 700 may be rearranged or otherwise modified such that other implementations are possible.

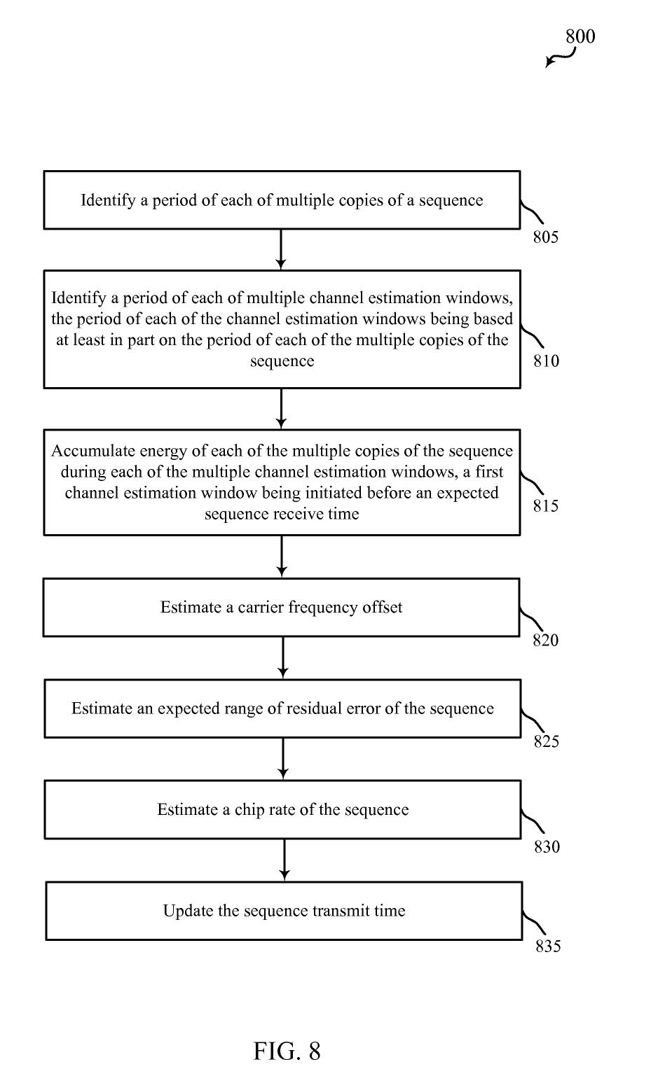

FIG. 8 shows a flow diagram, which illustrates a method 800 of channel estimation in a location tracking system, according to some embodiments. By way of illustration, the method 800 is implemented using the one or more of the devices and systems 100, 200, 300, 400, and 600 of FIGS. 1A, 1B, 2, 3, 4, and 6.

At block 805, the method may include identifying a period of each of multiple copies of a sequence. The operations at block 805 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 810, the method may involve identifying a period of each of multiple channel estimation windows, the period of each of the channel estimation windows being based on the period of each of the multiple copies of the sequence. The operations at block 810 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 815, the method may further include accumulating energy of each of the multiple copies of the sequence during each of the multiple channel estimation windows, a first channel estimation window being initiated before an expected sequence receive time. The operations at block 815 may in some cases be performed by the controller module 210 of FIG. 2; the controller module 210-a and/or the accumulator modules 310 of FIG. 3A; the processor and scheduler module 420 of FIG. 4; and/or the processor module 610 of FIG. 6.

At block 820, the method may involve estimating a carrier frequency offset. The operations at block 820 may in some cases be performed by the controller module 210 of FIG. 2; the controller module 210-a and/or the sample rate conversion module 305 of FIG. 3A; the processor and scheduler module 420 of FIG. 4; and/or the processor module 610 and/or the carrier frequency offset module 650 of FIG. 6.

At block 825, the method may include estimating an expected range of residual frequency error of the sequence. The operations at block 825 may in some cases be performed by the controller module 210 of FIG. 2; the controller module 210-a and/or the sample rate conversion module 305 of FIG. 3A; the processor and scheduler module 420 of FIG. 4; and/or the processor module 610 and/or the residual error estimation module of FIG. 6.

At block 830, the method may also include estimating a chip rate of the sequence. The operations at block 830 may in some cases be performed by the controller module 210 of FIG. 2; the controller module 210-a and/or the sample rate conversion module 305 of FIG. 3A; the processor and scheduler module 420 of FIG. 4; and/or the processor module 610 and/or the chip rate estimation module of FIG. 6.

At block 835, the method may further involve updating the expected sequence receive time. The operations at block 830 may in some cases be performed by the controller module 210 of FIG. 2; the controller module 210-a, the sample rate conversion module 305, and/or the sample time correction module of FIG. 3A; the processor and scheduler module 420 and/or the timer module 470 of FIG. 4; and/or the processor module 610 and/or the receive time determination module 640 of FIG. 6.

A skilled artisan will notice that the method 800 illustrates one implementation of the tools and techniques described herein. The operations of the method 800 may be rearranged or otherwise modified such that other implementations are possible.

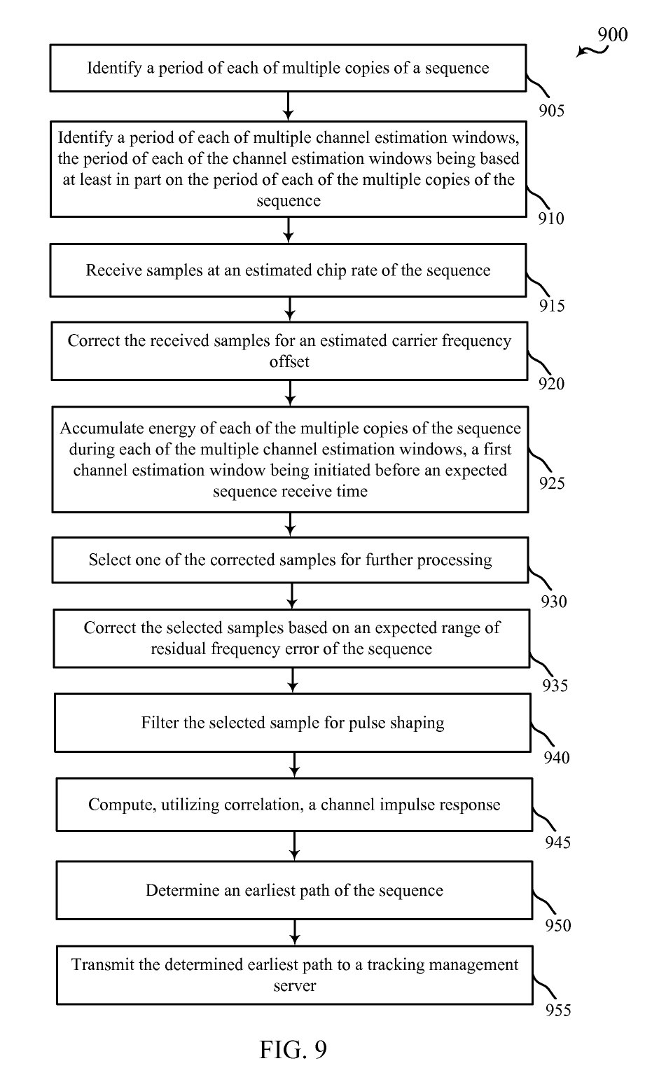

Turning now to FIG. 9, which shows a flow diagram illustrating a method 900 of channel estimation in a location tracking system, according to some embodiments. By way of illustration, the method 900 is implemented using the one or more of the devices and systems 100, 200, 300, 400, and 600 of FIGS. 1A, 1B, 2, 3, 4, and 6.

At block 905, the method may include identifying a period of each of multiple copies of a sequence. The operations at block 905 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 910, the method may involve identifying a period of each of multiple channel estimation windows, the period of each of the channel estimation windows being based on the period of each of the multiple copies of the sequence. The operations at block 910 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 915, the method may further include receiving samples at an estimated chip rate of the sequence. The operations at block 915 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 920, the method may also include correcting the received samples for an estimated carrier frequency offset. The operations at block 915 may in some cases be performed by the controller module 210 of FIG. 2; the controller module 210-a and/or the sample rate conversion module 305 of FIG. 3A; the processor and scheduler module 420 of FIG. 4; and/or the processor module 610 of FIG. 6.

At block 925, the method may involve accumulating energy of each of the multiple copies of the sequence during each of the multiple channel estimation windows, a first channel estimation window being initiated before an expected sequence receive time. The operations at block 925 may in some cases be performed by the controller module 210 of FIG. 2; the controller module 210-a and/or the accumulator modules 310 of FIG. 3A; the processor and scheduler module 420 of FIG. 4, and/or the processor module 610 of FIG. 6.

At block 930, the method may also involve selecting one of the corrected sample buffers for further processing. The operations at block 925 may in some cases be performed by the controller module 210 of FIG. 2; the controller module 210-a and/or the frequency bin selection module 315 of FIG. 3A; the processor and scheduler module 420 of FIG. 4, and/or the processor module 610 of FIG. 6.

Additionally, the method may include, at block 935, correcting the selected samples based on an expected range of residual frequency error of the sequence. The operations at block 935 may in some cases be performed by the controller module 210 of FIG. 2; the controller module 210-a and/or the residual frequency correction module 320 of FIG. 3A; the processor and scheduler module 420 of FIG. 4, and/or the processor module 610 of FIG. 6.

At block 940, the method may also involve filtering the selected sample for pulse shaping. The operations at block 935 may in some cases be performed by the controller module 210 of FIG. 2; the controller module 210-a and/or the receive filter module 325 of FIG. 3A; the processor and scheduler module 420 of FIG. 4, and/or the processor module 610 of FIG. 6.

At block 945, the method may include computing, utilizing correlation, a channel impulse response. The operations at block 945 may in some cases be performed by the controller module 210 of FIG. 2; the controller module 210-a and/or the channel impulse response computation module 330 of FIG. 3A; the processor and scheduler module 420 of FIG. 4, and/or the processor module 610 of FIG. 6.

At block 950, the method may also involve determine an earliest path of the sequence. The operations at block 950 may in some cases be performed by the controller module 210 of FIG. 2; the controller module 210-a and/or the residual frequency correction module 340 of FIG. 3A; the processor and scheduler module 420 of FIG. 4, and/or the processor module 610 of FIG. 6.

At block 955, the method may also include transmitting the determined earliest path to a tracking management server. The operations at block 955 may in some cases be performed by the controller module 210 and/or the transmitter module 215 of FIG. 2; the controller module 210-a and/or the earliest path detection module 340 of FIG. 3A; the processor and scheduler module 420 of FIG. 4, and/or the processor module 610 of FIG. 6.

It will be apparent to those skilled in the art that the method 900 is but one implementation of the tools and techniques described herein. The method 900 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not to be limited to the examples and designs described herein but is to be accorded the widest scope consistent with the principles and novel features disclosed herein.

What is claimed is:

1. A method to perform channel estimation, comprising:
identifying a period of each of multiple copies of a sequence;
identifying a period of each of multiple channel estimation windows, the period of each of the channel estimation windows being based at least in part on the period of each of the multiple copies of the sequence; and
accumulating energy of each of the multiple copies of the sequence during each of the multiple channel estimation windows, a first channel estimation window being initiated before an expected sequence receive time.

2. The method of claim 1, further comprising:
estimating a carrier frequency offset; and
estimating an expected range of residual frequency error of the sequence.

3. The method of claim 1, further comprising:
estimating a chip rate of the sequence.

4. The method of claim 1, wherein the accumulating energy of each of the multiple copies of the sequence comprises:
receiving samples at an estimated chip rate of the sequence; and
correcting the received samples for an estimated carrier frequency offset.

5. The method of claim 4, further comprising:
selecting one of the corrected sample buffers for further processing.

6. The method of claim 5, further comprising:
correcting the selected sample based at least in part on an expected range of residual frequency error of the sequence.

7. The method of claim 5, further comprising:
filtering the selected sample for pulse shaping.

8. The method of claim 5, further comprising:
computing, utilizing correlation, a channel impulse response.

9. The method of claim 8, further comprising:
determining an earliest path of the sequence.

10. The method of claim 9, further comprising:
transmitting the determined earliest path to a tracking management server.

11. The method of claim 1, further comprising:
updating the expected sequence receive time.

12. The method of claim 1, wherein the expected sequence receive time comprises a scheduled time mapped to a local timer at one or more access points.

13. The method of claim 1, wherein the accumulating energy of each of the multiple copies of the sequence comprises:
coherently accumulating energy of each of the multiple copies of the sequence.

14. The method of claim 1, wherein the sequence has a perfect autocorrelation property.

15. The method of claim 1, wherein the sequence comprises a ternary sequence.

16. A system for channel estimation, comprising:
means for identifying a period of each of multiple copies of a sequence;
means for identifying a period of each of multiple channel estimation windows, the period of each of the channel estimation windows being based at least in part on the period of each of the multiple copies of the sequence; and
means for accumulating energy of each of the multiple copies of the sequence during each of the multiple channel estimation windows, a first channel estimation window being initiated before an expected sequence receive time.

17. The system of claim 16, further comprising:
means for estimating a carrier frequency offset; and
means for estimating an expected range of residual frequency error of the sequence.

18. The system of claim 16, further comprising:
means for estimating a chip rate of the sequence.

19. The system of claim 16, wherein the means for accumulating energy of each of the multiple copies of the sequence comprises:
means for receiving samples at an estimated chip rate of the sequence; and
means for correcting the received samples for an estimated carrier frequency offset.

20. The system of claim 19, further comprising:
means for selecting a corrected sample buffer for further processing.

21. The system of claim 20, further comprising:
means for correcting the selected sample based at least in part on an expected range of residual frequency error of the sequence.

22. The system of claim 20, further comprising:
means for filtering the selected sample for pulse shaping.

23. The system of claim 20, further comprising:
means for computing, utilizing correlation, a channel impulse response.

24. The system of claim 23, further comprising:
means for determining an earliest path of the sequence.

25. The system of claim 24, further comprising:
means for transmitting the determined earliest path to a tracking management server.

26. The system of claim 16, further comprising:
means for updating the expected sequence receive time.

27. The system of claim 16, wherein the expected sequence receive time comprises a scheduled time mapped to a local timer at one or more access points.

28. The system of claim 16, wherein the means for accumulating energy of each of the multiple copies of the sequence comprises:
means for coherently accumulating energy of each of the multiple copies of the sequence.

29. The system of claim 16, wherein the sequence has a perfect autocorrelation property.

30. The system of claim 16, wherein the sequence comprises a ternary sequence.

31. An apparatus for channel estimation, comprising:
a processor;
memory in electronic communication with the processor; and
instructions stored in the memory, the instructions being executable by the processor to cause the apparatus to:
identify a period of each of multiple copies of a sequence;
identify a period of each of multiple channel estimation windows, the period of each of the channel estimation windows being based at least in part on the period of each of the multiple copies of the sequence; and
accumulate energy of each of the multiple copies of the sequence during each of the multiple channel estimation windows, a first channel estimation window being initiated before an expected sequence receive time.

32. The apparatus of claim 31, wherein the instructions are further executable to cause the apparatus to:
estimate a carrier frequency offset; and
estimate an expected range of residual frequency error of the sequence.

33. The apparatus of claim 31, wherein the instructions are further executable to cause the apparatus to:
estimate a chip rate of the sequence.

34. The apparatus of claim 31, wherein the instructions executable by the processor to accumulate energy of each of the multiple copies of the sequence during each of the multiple channel estimation windows are executable to cause the apparatus to:
receive samples at an estimated chip rate of the sequence; and
correct the received samples for an estimated carrier frequency offset.

35. The apparatus of claim 34, wherein the instructions are further executable to cause the apparatus to:
select the corrected sample buffer for further processing.

36. The apparatus of claim 35, wherein the instructions are further executable to cause the apparatus to:
correct the selected sample based at least in part on an expected range of residual frequency error of the sequence.

37. The apparatus of claim 35, wherein the instructions are further executable to cause the apparatus to:
filter the selected sample for pulse shaping.

38. The apparatus of claim 35, wherein the instructions are further executable to cause the apparatus to:
compute, utilizing correlation, a channel impulse response.

39. The apparatus of claim 38, wherein the instructions are further executable to cause the apparatus to:
determine an earliest path of the sequence.

40. The apparatus of claim 39, wherein the instructions are further executable to cause the apparatus to:
transmit the determined earliest path to a tracking management server.

41. The apparatus of claim 31, wherein the instructions are further executable to cause the apparatus to:
update the expected sequence receive time.

42. A computer program product for channel estimation, the computer program product comprising a non-transitory computer-readable medium storing instructions executable by a processor to cause an apparatus to:
identify a period of each of multiple copies of a sequence;
identify a period of each of multiple channel estimation windows, the period of each of the channel estimation windows being based at least in part on the period of each of the multiple copies of the sequence; and
accumulate energy of each of the multiple copies of the sequence during each of the multiple channel estimation windows, a first channel estimation window being initiated before an expected sequence receive time.

43. The computer program product of claim 42, wherein the instructions are further executable to cause a processor to:
estimate a carrier frequency offset; and
estimate an expected range of residual frequency error of the sequence.

44. The computer program product of claim 42, wherein the instructions are further executable to cause a processor to:
estimate a chip rate of the sequence.

45. The computer program product 42, wherein the instructions executable by the processor to accumulate energy of each of the multiple copies of the sequence during each of the multiple channel estimation windows are executable to cause the apparatus to:
receive samples at an estimated chip rate of the sequence; and
correct the received samples for an estimated carrier frequency offset.

46. The computer program product of claim 45, wherein the instructions further comprise instructions executable to cause the processor to:
select the corrected sample buffer for further processing.

47. The computer program product of claim 46, wherein the instructions are further executable to cause the apparatus to:
correct the selected sample based at least in part on an expected range of residual frequency error of the sequence.

48. The computer program product of claim 46, wherein the instructions are further executable to cause the apparatus to:
filter the selected sample for pulse shaping.

49. The computer program product of claim 46, wherein the instructions are further executable to cause the apparatus to:
compute, utilizing correlation, a channel impulse response;
determine an earliest path of the sequence; and
transmit the determined earliest path of the sequence to a tracking management server.

50. The computer program product of claim 42, wherein the instructions are further executable to cause the apparatus to:
update the expected sequence receive time.
